(19) United States
(12) Patent Application Publication
(10) Pub. No.: US 2024/0358172 A1
(43) Pub. Date: Oct. 31, 2024

(54) SYSTEMS AND METHODS FOR OPERATING MODULAR FOOD LOCKERS

(71) Applicant: Cargill, Incorporated, Wayzata, MN (US)

(72) Inventors: Daran Han, Minneapolis, MN (US); Kristen Kleppe, Osseo, MN (US); Eric Parkin, Plymouth, MN (US); Nathan Patrick Shrader, Chanhassen, MN (US); Jared Hansen Swarts, Otsego, MN (US)

(73) Assignee: Cargill, Incorporated, Wayzata, MN (US)

(21) Appl. No.: 18/572,630

(22) PCT Filed: Jun. 21, 2022
(86) PCT No.: PCT/US2022/073053

§ 371 Date: Dec. 20, 2023

Related U.S. Application Data
(60) Provisional application No. 63/213,402, filed on Jun. 22, 2021.

(51) Int. Cl. A47F 10/06; G06Q 10/0836

(52) U.S. Cl. CPC A47F 10/06; G06Q 10/0836

(57) ABSTRACT

Embodiments of the disclosure are directed to a food locker system, apparatus, and method for receiving food order from a user computing device, adding the food order to a preparation queue, causing a preparer computing device to display elements of the food order, receiving from the preparer user device an indication the food order has been placed in the a food locker, sending an indication to the user computing device that the food order has been placed in the food locker, and instructing the food locker to unlock based on input received from the user computing device.

### CROSS-REFERENCE TO RELATED APPLICATIONS

This application claims priority to U.S. Provisional Patent Application No. 63/213,402, filed Jun. 22, 2021, which is incorporated herein by reference in its entirety.

### BACKGROUND

Traditional modes of fast food preparation are geared towards preparing and providing food quickly. For example, in a short order arrangement, customer orders are taken and orders are prepared quickly while the customers wait. Take out and delivery options are also available. In a take-out arrangement, a customer's food order is prepared and provided to the customer on arrival, usually with human intervention. In a delivery scenario, the establishment preparing the food or a third party picks up a food order when it is prepared and delivers the food order to the customer, for example, at the customer's home.

### BRIEF DESCRIPTION OF DRAWINGS

The present disclosure is illustrated by way of example and not limitation in the following figures.

FIG. 1 is a diagram showing one example of an environment for fulfilling food orders using a food locker bank and locker management server.

FIG. 2 is a diagram showing one example of a food locker bank.

FIG. 3 is a flowchart showing one example of a process flow that may be executed by a locker management server to manage a food order.

FIG. 4 is a block diagram illustrating an example workflow that may be implemented by a locker management server to manage food orders for a food locker bank.

FIG. 5 is a flowchart showing another example of a process flow that may be executed by a locker management server to manage a food order.

FIG. 6 is a flowchart showing one example of a process flow that may be executed in a food locker environment to receive a food order.

FIG. 7 is a flowchart showing one example of a process flow that may be executed in a food locker environment to receive a food order according to a just-in-time preparation arrangement.

FIG. 8 is a flowchart showing one example of a process flow that may be executed in a food locker environment to fulfill a food order.

FIG. 9 is a diagram showing one example of a user interface screen that may be provided with the provider user interface.

FIG. 10 is a diagram showing example of the user interface screen of FIG. 9 at a later point in time than what is depicted in FIG. 9.

FIG. 11 is a diagram showing an example of the user interface of FIG. 9 and illustrating an empty locker routine.

FIG. 12 is a block diagram showing one example of a software architecture for a computing device.

FIG. 13 is a block diagram of a machine in the example form of a computer system within which instructions may be executed for causing the machine to perform any one or more of the methodologies discussed herein.

### DETAILED DESCRIPTION

Various examples described herein are directed to systems, apparatuses, and methods for fulfilling customer food orders using modular food lockers.

Existing food distribution systems have certain disadvantages, especially with increasing demand for pick-up and delivery orders. Consider an example drive-in establishment. A customer makes a food order for drive-through pickup and then positions their vehicle in a drive-in line. The customer receives his or her food items when his or her vehicle reaches the head of the drive-in line. Often the sequence in which drive-in food orders can be serviced is limited by the sequence in which the customers have queued their vehicles in the drive-in line. This can cause delays for customers. For example, customers positioned in the drive-in line after customers having food orders that take longer to prepare may wait longer than needed. Also, the number of drive-in food orders that can be received at one time is limited by space available for vehicles to wait in the drive-in line. Customers who observe a jammed drive-in line at an establishment may forgo making a food order that would have otherwise been made.

Consider another example food order distribution problem for establishments operating at sporting events, airports, concerts, or similar large events. These establishments may typically receive walk-up orders. Customers may place their order at a counter and then wait near the counter until their order is ready pick-up. Once again, during times of high demand, customer queueing can cause issues. The number of orders that can be received at one time may be limited by the space available for customers to wait on their orders. Also, at many events, customers may not want to miss certain parts of the event itself. For example, a customer may want to pick-up a food order at an intermission of a game or concert or between innings of a baseball game. Customers may avoid making food orders if the food orders cannot be consistently provided for pick-up during event breaks.

Various examples described herein utilize remote food ordering. According to remote food ordering, a customer places a food order using a computing device. The food order may be placed at the restaurant, kiosk, or other establishment where the food items will be prepared and/or placed remotely. The customer is apprised of an estimated time of delivery for the food order and reports to the establishment at or near the indicated time to receive their food items.

The use of remote food ordering, however, also generates complications. For example, directing customers to their remotely-placed orders can create a challenge. An establishment may need to assign staff to prevent customers from inadvertently picking up the wrong food items and/or to prevent malicious actors from stealing someone else's food items. The need for additional staffing may mitigate or even eliminate the advantages of remote ordering.

In various examples, these and other challenges may be addressed by performing food distribution using one or more food locker banks. Food locker banks may be operated by a restaurant, kiosk, or other establishment. The food lockers can be positioned at the establishment and/or at another suitable location for food pick-up, such as a food order hub where different restaurants can deliver food for pickup or delivery.

A food locker includes one or more compartments for storing all or part of a food order. In some examples, the food locker includes heating and/or cooling elements to maintain the one or more compartments at a suitable temperature for preserving food items for fulfilling a food order. The food locker may include a door that can be opened to place one or more food items in the food locker and/or remove the one or more food items from the food locker. In some examples, a food locker includes multiple doors including at least a first door that can be used by a preparer to place a food order in the food locker and at least a second door that can be used by a customer to remove the food order from the food locker. The food locker also comprises a remotely-actuatable lock that can be selectively locked to prevent food items from being removed from the food locker or unlocked to permit food items from being removed from the food locker.

In some examples, the food lockers are modular and are arranged into a food locker banks. For example, an establishment may position a food locker bank at or near an existing counter or other location where customers can pick-up food orders. A food locker bank comprises a number of food lockers. The food lockers in a food locker bank may be of the same type or of different types. For example, a food locker bank may include food lockers having different types of heating or cooling elements for compartments, different numbers of compartments for storing food orders, different sizes or shapes of compartments, etc. In some examples, some or all of the food lockers making up a food locker bank are electrically and/or mechanically coupled to one another.

In various examples, a locker management server manages food orders fulfilled using one or more food locker banks. The locker management server can be in communication with user computing devices, with one or more individual lockers, and/or with one or more preparer computing devices associated with food order preparers at the establishment. The locker management server may mange food orders throughout the order lifecycle.

In some examples, the locker management server receives a food order made by a customer via a user computing device. The food order may be made directly by a customer who will pick up the food item or items of the food order at a designated food locker. In other examples, the food order is made by a delivery service, where a party from the delivery service picks up the food order at the designated food locker and delivers the food order to a customer. In some examples, the food order is made by a customer using a computing device application that instructs the locker management server to coordinate the preparation of the food order and instructs a third-party delivery service to send a party to pick-up the food order at the locker bank and deliver it to the customer.

The locker management server may assign a received food order to a preparation queue. The preparation queue is a queue of food orders arranged in a sequence based on when the food orders should be prepared. Some or all of preparation queue is provided to one or more preparers via a preparer interface. The preparer user interface is provided to one or more preparer computing devices. For example, preparer computing devices may be positioned at the kitchen or other food preparation area of the establishment fulfilling the food orders.

The locker management server may also assign a received food order to one or more food lockers of the food locker bank. The assigned food locker for a food order may be communicated to one or more of the preparers via the preparer interface. When the preparer completes the food items for a food order, the preparer places the food items in the assigned food locker or food lockers for the order.

The locker management server may also communicate the assigned food locker or lockers for a food order to the customer or other party that is to pickup the food order. When the customer or other party is present at the food locker bank, the locker management server sends a message to the assigned food locker instructing the assigned food locker to unlock the remotely-actuatable lock. In this way, the customer or other party may remove the food item or items making up the food order from the food locker or food lockers including the food items.

The arrangements described herein may address one or more food distribution challenges. For example, the locker management server, as described herein, may separate the sequence in which food orders are received from the sequence in which the food orders are fulfilled. For example, a received order may be placed into the preparation queue at a position based on when the order is to be picked up and not necessarily based on when the order is received. In some examples, a food order is placed into the preparation queue using a preparation condition for the food order. A preparation condition describes an aspect of the food order will be prepared. An example preparation condition is a preparation time (e.g., how long it will take to prepare the food for the food order). For example, a food order having a relatively long preparation time may be placed in the preparation queue earlier (e.g., for earlier preparation) than a food order with a shorter preparation time. In this way, the preparation and fulfillment of orders may be optimized, for example, based on how long it will take to prepare the order and on when the customer or other person intends to pick up the food items of the food order. These and various other advantages are described herein.

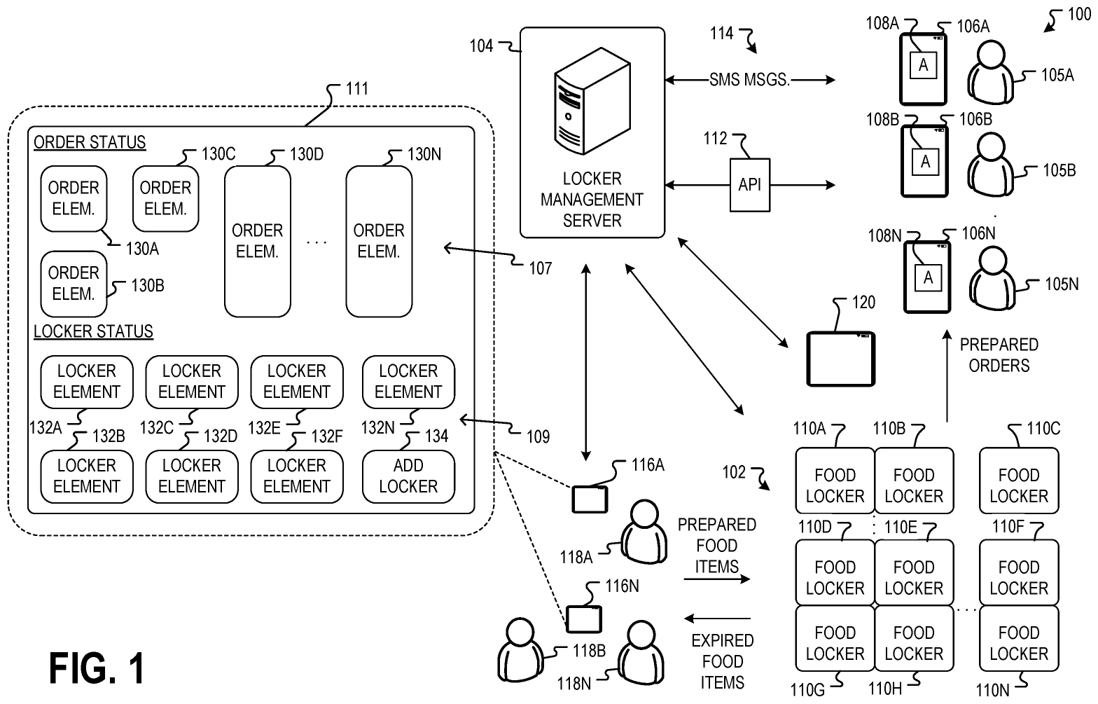

FIG. 1 is a diagram showing one example of an environment 100 for fulfilling food orders using a food locker bank 102 and locker management server 104. The food locker bank 102 includes a number of food lockers 110A, 110B, 110C, 110D, 110E, 110F, 110G, 110H, 110N. Although nine food lockers 110A, 110B, 110C, 110D, 110E, 110F, 110G, 110H, 110N are shown in FIG. 1, in various examples different numbers of food lockers may be included in a food locker bank 102. Also, the food locker bank 102 includes food lockers 110A, 110B, 110C, 110D, 110E, 110F, 110G, 110H, 110N that are positioned together. In some examples, however, a food locker bank 102 may include food lockers in multiple locations. For example, an establishment may operate a food locker bank 102 having some food lockers 110A, 110B, 110C, 110D, 110E, 110F, 110G, 110H, 110N positioned near a counter for customer pick-up and other food lockers 110A, 110B, 110C, 110D, 110E, 110F, 110G, 110H, 110N positioned at another location for pick-up by one or more delivery drivers.

The locker management server 104 is also in communication with one or more user computing devices 106A, 106B, 106N. User computing devices 106A, 106B, 106N may be or include any suitable computing device or devices such as, for example, a smart phone, a tablet computer, a laptop computer, a smart watch, etc. In this example, user computing devices 106A, 106B, 106N execute applications 108A, 108B, 108N. Users 105A, 105B, 105N associated with the various user computing devices 106A, 106B, 106N may utilize the applications 108A, 108B, 108N to communicate with the locker management server 104. For example, the locker management server 104 and/or applications 108A, 108B, 108N may implement an application program interface (API) 112. Some communications between the applications 108A, 108B, 108N may be via the API 112. Also, some communications between the user computing devices 106A, 106B, 106N may be via short message service (SMS) 114 or any other suitable communication technique.

The locker management server 104 may also be in communication with one or more preparer computing devices 116A, 116N. Preparer computing devices 116A, 116N may be or include any suitable computing device or devices such as, for example, a smart phone, a tablet computer, a laptop computer, a smart watch, etc. Preparer computing devices 116A, 116N may be positioned at an area of the establishment where food orders are prepared. The preparer computing devices 116A, 116N may be associated with various preparers 118A, 118B, 118N. Preparers 118A, 118B, 118N prepare food orders and provide prepared food items to the various food lockers 110A, 110B, 110C, 110D, 110E, 110F, 110G, 110H, 110N for pickup by customers 105A, 105B, 105N or other parities (e.g., delivery drivers). In some examples, a single preparer 118A is assigned a dedicated preparer computing device 116A. In other examples, a single preparer computing device 116N is shared by multiple preparers 118B, 118N. Preparer computing devices 116A, 116N may provide the preparers 118A, 118B, 118N with the preparer user interface 111.

The locker management server 104, in some examples, is also in communication with a food locker bank display 102. The food locker bank display 102 may be a computing device, as described herein, or may be a monitor associated with one or more of the food lockers 110A, 110B, 110C, 110D, 110E, 110F, 110G, 110H, 110N. The locker management server 104 may provide the food locker bank display 120 with information describe food orders present in the various food lockers 110A, 110B, 110C, 110D, 110E, 110F, 110G, 110H, 110N, for example, to provide customers 105A, 105B, 105N with an indication of which food locker encloses their food items.

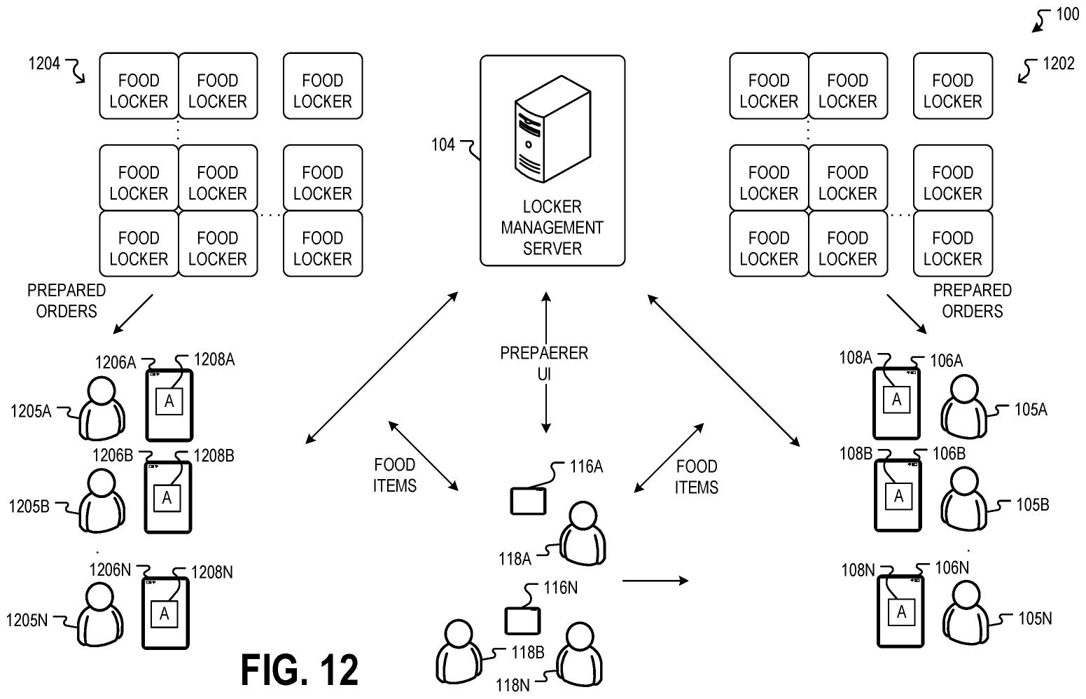

A customer 105A, 105B, 105N may make a food order via the application 108A, 108B, 108N. The application 108A, 108B, 108N may be associated with the organization implementing the locker management server 104 and/or with the establishment fulfilling the food order. For example, the establishment may use the application 108A, 108B, 108N to provide menu information about food items that can be ordered including, for example, prices, nutrition information, etc. The customer 105A, 105B, 105N may select one or more food items to be part of a food order and may select to have the food order fulfilled for pick-up at the locker bank 102. In some examples, the application 108A, 108B, 108N allows the user to select a fulfillment option for a food order. For example, the customer 105A, 105B, 105N may pick-up the order. In some examples, the customer 105A, 105B, 105N may select a delivery option whereby a third-party delivery service picks up the food order at the locker bank and delivers the food order to the customer 105A, 105B, 105N. More details of example variations supporting third-party delivery are described herein, for example, with respect to FIG. 12.

A food order may be provided to the locker management server 105, for example, via the API 112. The locker management server 104 may add the received food order to a preparation queue. The preparation queue is a queue of food orders arranged in a sequence corresponding to when the food orders should be prepared. In some examples, as described herein, food orders may not be added to the preparation queue in the order that they were received. For example, the received food order may be associated with an arrival time when the customer 105A, 105B, 105N or other party picking up the food order is to arrive at the food locker bank 102. The food order may be placed in the preparation queue to be ready at about the arrival time. The arrival time may be predetermined, for example, at the time that the food order is placed and/or may be an actual arrival time, for example, based on when the user or other party checks-in to pick-up the order.

In some examples, placement of a food order into the preparation queue is also based on one or more preparation conditions for the food order. For example, a preparation condition may describe how one or more food items of the food order are to be prepared. For example, a preparation condition may indicate that a food item of a food order needs to be fried, brewed, or subjected to another preparation step that is more time consuming that other steps. A preparation condition may also indicate a sequence of preparation steps for one or more food items. For example, a preparation condition for a chicken sandwich may indicate that the chicken for the sandwich may need to be fried for X minutes, and then that the sandwich should be prepared taking another Y minutes.

In some examples, the locker management server 104 executes a trained machine-learning model to determine the sequence of food orders in the preparation queue. For example, the model may receive as input various factors describing a food order or all of the food orders in the preparation queue including, for example, food items making up the food order, preparation conditions for the food order, fulfillment options selected by the customer, an arrival time indicated by the customer at the time that the order is made, an actual arrival time when the customer checks-in to the locker management server 104, or any other suitable factors.

Any suitable type of machine learning model may be used including, for example, a supervised learning model, an unsupervised model, a semi-supervised model, an adversarial model, etc. Example model types that may be used include nearest neighbor models, naive bayes models, decision tree models, linear regression models, support vector machine (SVM) models, neural network models, k-means clustering models, association rules models, Q-learning models, temporal difference (TD) models, deep adversarial network models, etc.

A machine learning model may be trained with training data. For example, the training data may include information about previous food orders and their corresponding actual arrival times. The training data may be labeled or unlabeled. The machine learning model is trained, using the training data, to model a relationship between various the various factors describing a food order and the actual arrival time. When a new food order is received, the locker management server applies the trained machine learning model to determine an estimated arrival time for the food order. The food order may be placed in the preparation queue based on the estimated arrival time.

Some or all of the food orders in the preparation queue are communicated to the preparers 118A, 118B, 118N via the preparer user interface 111. The preparer user interface 111 may be provided to the one or more preparers 118A, 118B, 118N via a display or other suitable input/output (I/O) device of the preparer computing devices 116A, 116N. In the example of FIG. 1, the preparer user interface 111 comprises an order status field 107 and a locker status field 109. Order status field comprises order elements 130A, 130B, 130C, 130D, 130N. Order elements 130A, 130B, 130C, 130D, 130N may correspond to food orders in the preparation queue.

Order elements 130A, 130B, 130C, 130D, 130N may be visual elements displayed on a screen of the preparer computing device 116A, 116N. Order elements 130A, 130B, 130C, 130D, 130N may indicate information about respective orders in the preparation queue. For example, an order element 130A may include information about a first food order in the preparation queue, order element 130B may include information about a second food order in the preparation queue, and so on. Information about a food order included in an order element may include, for example, an order identifier and an indication of one or more food items in the food order, preparation instructions for the food order, and the like. An order identifier may include, for example, an order number, a name of the customer 105A, 105B, 105N who placed the food order, and/or the like. The indication of the one or more food items in the food order ma include a name of each food item, a name of a combination menu item including multiple food items, and/or the like.

Order elements 130A, 130B, 130C, 130D, 130N, in some examples, may also indicate an urgency of their corresponding food orders. The urgency of the food order indicates how soon the order should be prepared in order to have the corresponding food items deposited at the food locker bank 102 prior to the customer's arrival time. In some examples, an order element 130A, 130B, 130C, 130D, 130N indicates the urgency of its corresponding food order by including the customer arrival time and/or a timer counting down to the customer arrival time. Also, in some examples, an order element 130A, 130B, 130C, 130D, 130N indicates the urgency of its corresponding food order by including a delivery time by which a food order should be deposited at the food locker bank 102 to meet the customer's arrival time or a timer counting down to the delivery time. In some examples, an order element 130A, 130B, 130C, 130D, 130N indicates the urgency of its corresponding food order by its color or coloring. For example, order elements 130A, 130B, 130C, 130D, 130N corresponding to food orders that are on time or less urgent may be green and/or include green sub-elements. Order elements 130A, 130B, 130C, 130D, 130N corresponding to food orders that are more urgent may be yellow and/or include yellow sub-elements. Order elements 130A, 130B, 130C, 130D, 130N corresponding to food orders that are most urgent may be red and/or include red sub-elements.

In some examples, order elements 130A, 130B, 130C, 130D, 130N also indicate the identity of one or more food lockers 110A, 110B, 110C, 110D, 110E, 110F, 110G, 110H, 110N into which the food items making up an order are to be placed. In some examples, a food order may have a corresponding order element 130A, 130B, 130C, 130D, 130N before one or more food lockers 110A, 110B, 110C, 110D, 110E, 110F, 110G, 110H, 110N are assigned. For example, as described herein, food locker assignment for a food order may be assigned after the food order is in the preparation queue (e.g., at or near the customer's arrival time, after a customer checks-in, etc.). In these examples, an order element 130A, 130B, 130C, 130D, 130N may be initially displayed without indicating a food locker or food lockers for the order and then modified later to indicate the appropriate food locker or food lockers.

The preparer user interface 111 may also include one or more locker elements 132A, 132B, 132C, 132D, 132E, 132F, 132N. Each locker element 132A, 132B, 132C, 132D, 132E, 132F, 132N corresponds to a locker at the food locker bank 102. A locker element may indicate the status of its corresponding food locker including, for example, an indication of whether food items for a food order are present in the locker, an identifier of the food order having food items in the locker, an indication of whether a locker light is illuminated, an indication of whether a pickup period for food items in the locker has expired, an indication of whether the locker is ready to receive food items, and the like. The pickup period may be a threshold time that the food items are to be left in a food locker 110A, 110B, 110C, 110D, 110E, 110F, 110G, 110H, 110N without being picked up before the food item is to be removed.

In the example of FIG. 1, the preparer user interface 111 also includes an add locker button 134. The add locker button 134 may be selected, for example, to add a food locker to the food locker bank 102. For example, when a food locker is added to the food locker bank 102, selecting the add locker button 134 may prompt locker management server 104 to establish communication with the added food locker. In some examples, a locker element may be added to the preparer user interface 111 for the newly added food locker.

The preparer user interface 111 may be generated at the preparer computing device 116A, 116N and/or at the locker management server 104. For example, the locker management server 104 may provide the preparer computing device 116A, 116N with information about various food orders in the preparation queue and/or with information about various lockers 110A, 110B, 110C, 110D, 110E, 110F, 110G, 110H, 110N. The preparer computing devices 116A, 116N may use the received information to render the preparer user interface 111 and/or update a rendering of the preparer user interface 111. In other examples, the locker management server 104 generates the preparer user interface 111 and servers it to the respective preparer computing devices 116A, 116N.

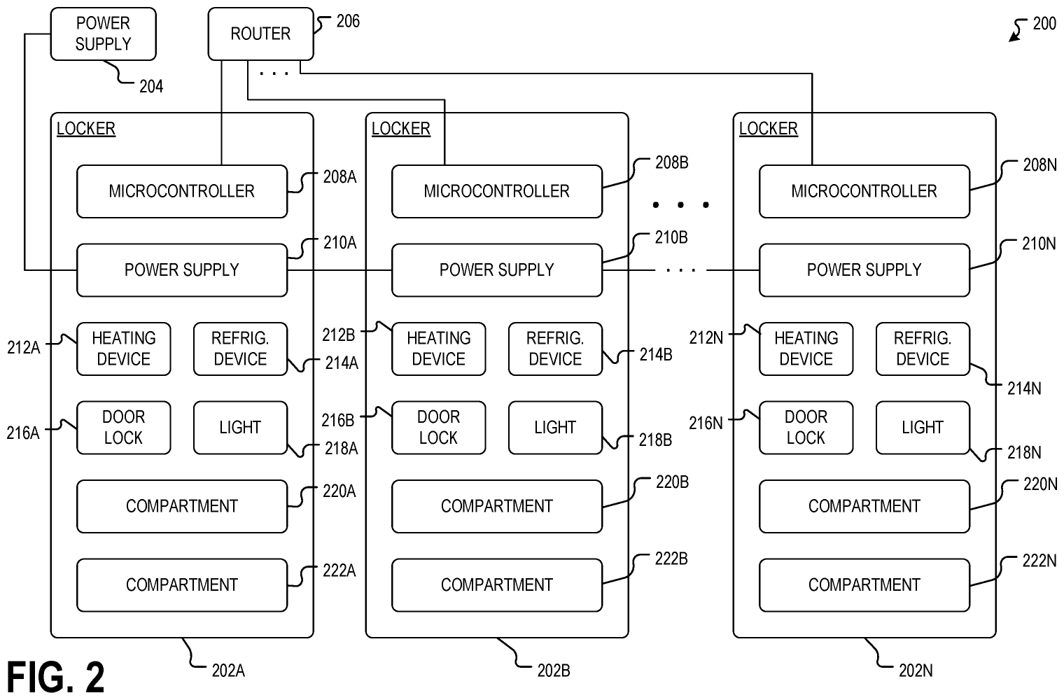

FIG. 2 is a diagram showing one example of a food locker bank 200. The food locker bank 200 comprises food lockers 202A, 202B, 202N. Although three food lockers 202A, 202B, 202N are shown in FIG. 2, a food locker bank may include any suitable number food lockers 202A, 202B, 202N. The food locker bank 200 also comprises a power supply 204 and a router 206. The power supply 204 provides power to the food lockers 202A, 202B, 202N of the food locker bank 200. In the example of FIG. 2, the food lockers 202A, 202B, 202N include power supplies 210A, 210B, 210N that are connected to the power supply 204 in a daisy chain arrangement.

The food lockers 202A, 202B, 202N also include microcontrollers 208A, 208B, 208N. Microcontrollers 208A, 208B, 208N include any suitable processor or computing device including a processor. In some examples, microcontrollers 208A, 208B, 208N can be or include a Raspberry Pi device, a Microsoft Azure Sphere R device. Microcontrollers 208A, 208B, 208N may be in wired or wireless communication with the router 206. In some examples, the router 206 utilizes a single Internet Protocol (IP) or similar address on a wide area network (WAN). The router 206 may implement a local area network (LAN) including the microcontrollers 208A, 208B, 208N of the respective food lockers 202A, 202B, 202N. In this way messages directed to the food lockers 202A, 202B, 202N of the food locker bank 200 may be directed to a single IP address at the router 206. The router may then direct received messages to the microcontroller 208A, 208B, 208N of the appropriate food locker 202A, 202B, 202N.

In the example of FIG. 2, the food lockers 202A, 202B, 202N also include respective compartments 220A, 220B, 220N, 222A, 222B, 222N. The compartments 220A, 220B, 220N, 222A, 222B, 222N may be for receiving and storing food items making up food orders stored at the respective food lockers 202A, 202B, 202N. In this example, each food locker 202A, 202B, 202N includes two compartments 220A, 220B, 220N, 222A, 222B, 222N. Various other arrangements can include food lockers 202A, 202B, 202N including more or fewer than two compartments 220A, 220B, 220N, 222A, 222B, 222N.

In the example of FIG. 2, the food lockers 202A, 202B, 202N include a heating device 212A, 212B, 212N and a refrigeration device 214A, 214B, 214N. Any suitable heating device 212A, 212B, 212N such as, for example, an electric heating element or the like. Similarly, any suitable refrigeration device 214A, 214B, 214N can be used such as, for example, a compressor-based arrangement. In some examples, the heating device 212A, 212B, 212N and cooling device 214A, 214B, 214N can be combined into a single device such as, for example, a Peltier device.

In some examples, the heating device 212A, 212B, 212N heats one compartment 220A, 220B, 220N while the refrigeration device 214A, 214B, 214N cools the other compartment 222A, 222B, 222N. In this way, each food locker 202A, 202B, 202N may comprise a hot compartment 220A, 220B, 220N for keeping hot food items and a cool compartment 222A, 222B, 222N for keeping cool food items. In some examples, the heating device 212A, 212B, 212N and/or refrigeration device 214A, 214B, 214N is omitted. For example, a food locker 202A, 202B, 202N may comprise a hot compartment only or a cold compartment only. Also, in some examples, one or more cold compartments may be cooled passively.

In some examples, the heating device 212A, 212B, 212N and/or refrigeration device 214A, 214B, 214N is in electrical communication with the microcontroller 208A, 208B, 208N. In this way, the microcontroller 208A, 208B, 208N may be programmed to selectively turn on, turn off, and/or adjust any other suitable settings of the heating device 212A, 212B, 212N and/or refrigeration device 214A, 214B, 214N. For example, the microcontroller 208A, 208B, 208N may be programmed to turn-on a heating device 212A, 212B, 212N when food items are placed within a compartment or when food items are scheduled to be placed within a compartment. The microcontroller 208A, 208B, 208N may be programmed to turn-off the heating device 212A, 212B, 212N when food items are removed from a compartment.

The food lockers 202A, 202B, 202N may also comprise a door lock 216A, 216B, 216N. Door locks 216A, 216B, 216N may be remotely actuatable to selectively lock or unlock a door or doors to the compartments 220A, 220B, 220N, 222A, 222B, 222N. In some examples, microcontroller 208A, 208B, 208N is electrically coupled to the door lock 216A, 216B, 216N to selectively lock or unlock the one or more doors. Door lock 216A, 216B, 216N may lock and/or unlock the one or more doors in any suitable manner. In some examples, door lock 216A, 216B, 216N comprises a solenoid that can be selectively energized or de-energized to lock or unlock the food locker 202A, 202B, 202N.

The food lockers 202A, 202B, 202N may also comprise respective lights 218A, 218B, 218N. Lights 218A, 218B, 218N may be selectively illuminated or turned-off by the microcontroller 208A, 208B, 208N to illuminate one or more of the compartments 220A, 220B, 220N, 222A, 222B, 222N. In some examples, lights 218A, 218B, 218N may be illuminated when a customer or other party is to retrieve a food order from the respective food locker 202A, 202B, 202N to indicate the correct locker to the customer.

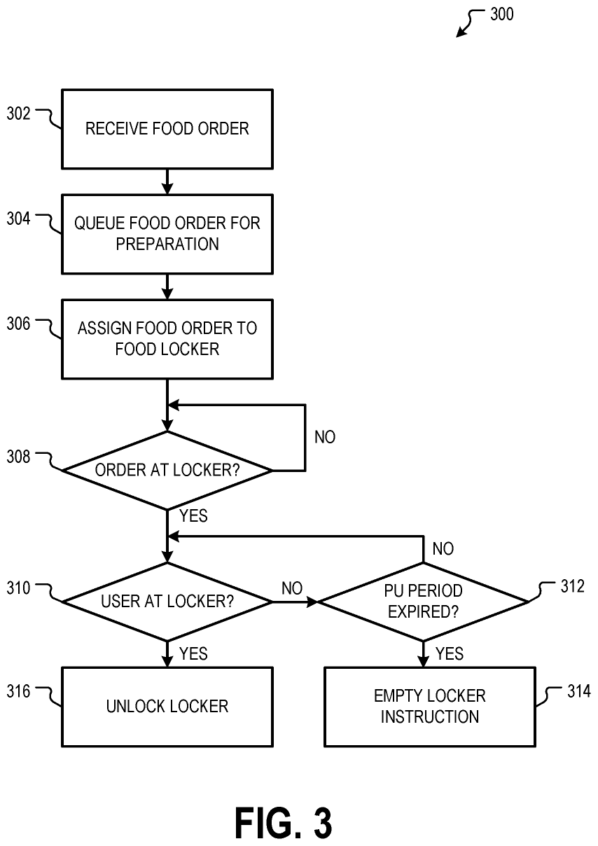

FIG. 3 is a flowchart showing one example of a process flow 300 that may be executed by a locker management server, such as the locker management server 104 of FIG. 1, to manage a food order. At operation 302, the locker management server receives a food order from a customer. The food order may indicate one or more food items for pickup by the customer at a food locker bank. In some examples, the food order indicates one or more food items for pickup by a delivery service at the food locker bank, where the delivery service then delivers the food order to the customer. The food order can be received in any suitable manner, as described herein. For example, the customer may utilize a user computing device, such as one of the devices 106A, 106B, 106N, that executes an application such as the application 108A, 108B, 108N. The order may be provided via an API, such as the API 112, implemented by the application 108A, 108B, 108N, the locker management server 104 or both.

At operation 304, the locker management server 104 assigns the food order to a preparation queue. The preparation queue is an ordered list of food orders that are to be prepared for delivery to a food locker bank. The locker management server 104 may assign the food order to a position in the preparation queue based on an arrival time when the customer (or delivery service) is expected to arrive to pickup the food order at the locker bank and/or one or more preparation conditions for the food order. All or part of the preparation queue may be provided to one or more preparers using a preparer user interface, as described herein.

At operation 306, the locker management server assigns the food order to a food locker at the food locker bank. The selected food locker is communicated to one or more preparers who prepare the food orders. The preparers may be instructed, for example, via the preparer user interface, to place the food order at the assigned food locker. The locker management server may also communicate the identity of the assigned food locker or food lockers to the customer or other party who will pick up the food items.

In some examples, the locker management server is in communication with the various food locker and selects a food locker based on its status. For example, the locker management server may select a food locker that is function, is not experiencing an error condition, and/or is empty (i.e., not storing another food order). In some examples, the locker management server assigns a food order to more than one food locker, for example, if the food order includes more food items than will fit in a single food locker. Also, in some examples, the locker management server assigns a food order to a food locker based on the specific needs of the food order. For example, an order including an ice cream food item may be assigned to a food locker have a suitable refrigeration device to keep at least one compartment cold enough to maintain the ice cream.

At operation 308, the locker management server determines whether the food order has been placed at the assigned locker. For example, the locker management server may receive an indication from the preparer via the preparer user interface that the food order has been placed in the assigned locker. In some examples, the locker management server receives a communication from the assigned locker that a door or door of the food locker has been opened to place the food order therein. If the order has not been placed at the food locker, the locker management server may again check at operation 308.

If the food order is present at the assigned food locker, the locker management server determines, at operation 310, whether the customer or other party picking up the order is present at the locker bank. For example, the customer or other party may send a check-in to the locker management server when the customer or other party is present at the locker bank, as described herein. In other examples, a user computing device used by the customer or other party provides the locker management server with a geolocation of the customer or other party. When the geolocation is within a threshold of the food locker bank, the customer or other party may be present at the food locker bank.

If the customer or other party is not present, the locker management server determines, at operation 312, whether a pickup period for the food order has expired. For example, if the food remains in the food locker too long it may be sub-optimal. Also, it may be desirable to prevent a single food order from occupying a food locker for too long. If the pickup period for an order has expired, then the locker management server may send an empty locker instruction to one or more preparers (e.g., via the preparer interface). The preparer may respond by removing the food items from the food locker, rendering the food locker available for a new food order.

If the pickup period for the food order has not expired at operation 312, the locker management server may determine again at operation 310 if the customer or other party is at the food locker to pickup the food order. If the customer or other party is present at the food locker, the locker management server may unlock the food locker at operation 316. Unlocking the food locker may include sending an electronic signal to the food locker instructing the food locker microcontroller to actuate the lock to allow the door or doors to be opened to remove the food items therein. In some examples, the locker management server also instructs the food locker to turn on a light at the food locker. This may illuminate the compartment or compartments including the food items, making it easier for the customer or other party to spot the appropriate food item.

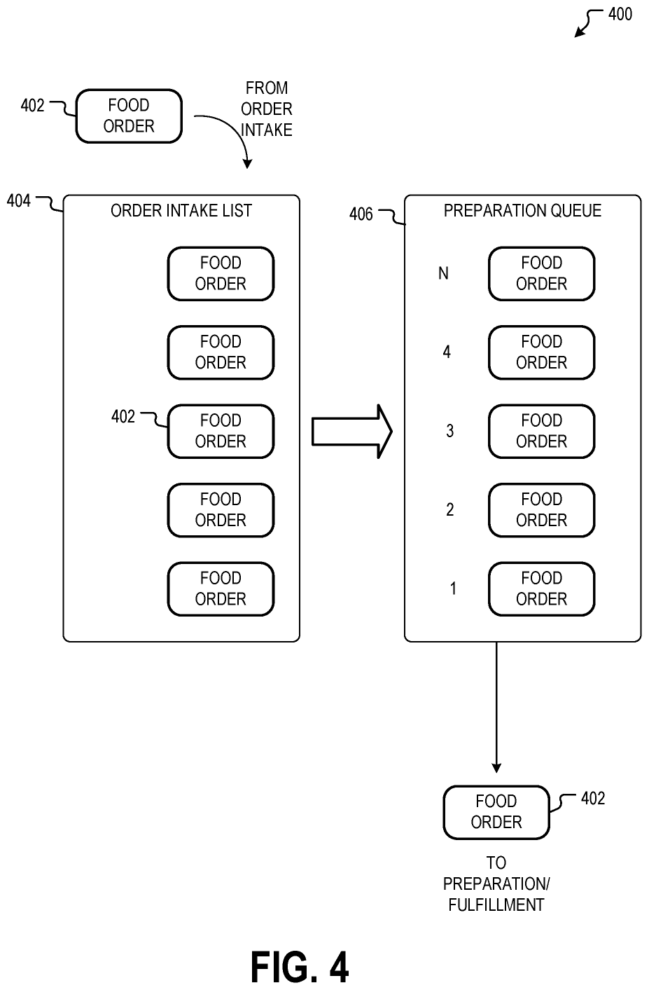

FIG. 4 is a block diagram illustrating an example workflow 400 that may be implemented by a locker management server to manage food orders for a food locker bank. The workflow 400 includes an order intake list 404 and an order preparation queue. The locker management server receives a food order 402 from a customer, for example, as described herein. When the food order is received, it is added to the order intake list 404, as shown. The order intake list 404, for example, may be or include a memory location or set of memory locations utilized by the locker management server. The order intake list 404 may include the food order 402 and other food orders received by the locker management server.

The locker management server assigns food orders from the order intake list 404 to a preparation queue 406. The preparation queue 406 comprises food orders arranged in a sequence according to which the food orders will be prepared. The preparation queue 406 may be stored, for example, at a set of memory locations used by the locker management server. In some examples, the preparation queue 406 may utilize the same memory locations as the order intake list. For example, the locker management server may add a food order to the preparation queue by associating the order with a position in the sequence according to which the food orders will be prepared. The position assigned to a food order, as described herein, may be determined based on the expected arrival time of the customer who placed the order or another party who will pick-up the food order from the locker bank and/or one or more preparation conditions for the food order.

Consider an example in which the locker management server receives two food orders. In this example, the first food order has an arrival time T1 and the second food order has an arrival time T2 such that T1 is before T2. The locker management server may assign an earlier position in the preparation queue to the first food order such that the first food order is prepared before the second food order.

Consider another example in which the locker management server receives two food orders having the same arrival time, where the two food orders include a first food order having a first preparation time and a second food order having a second preparation time longer than the first preparation time. In this example, the second food order may be placed in the preparation queue 406 at an earlier position than the first food order. In this way, preparation of the second food order may begin before preparation of the first food order even though, in this example, both food orders are to be completed at about the same time.

As described herein, some or all of the food orders in the preparation queue may provided to one or more preparers via the preparer user interface. When the food order 402 reaches an end of the preparation queue, it may be prepared and deposited at a food locker of the food locker bank as described herein.

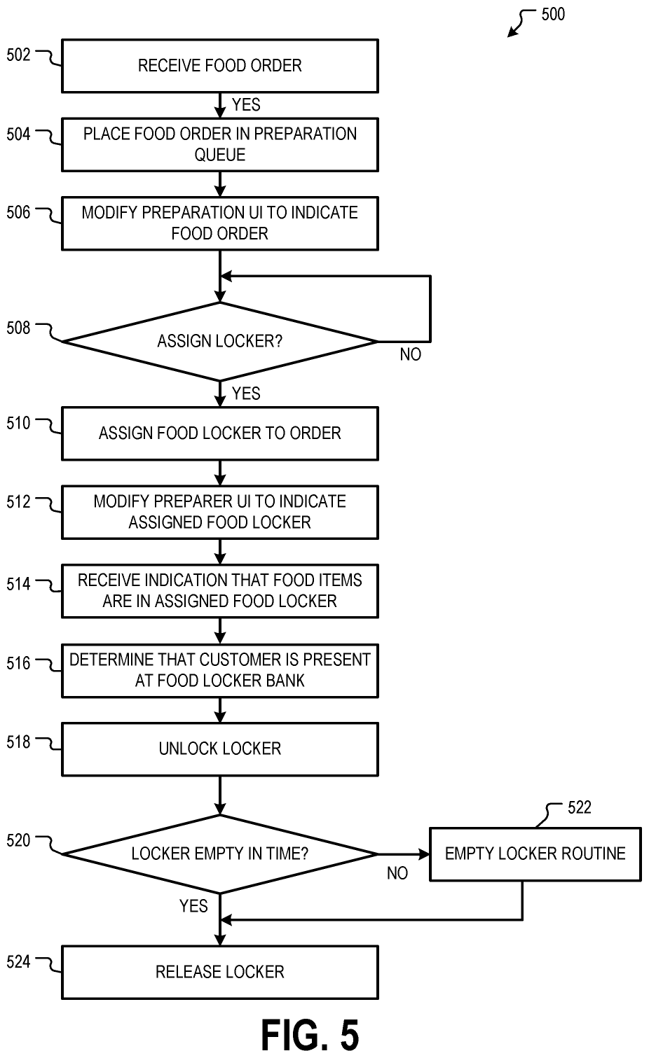

FIG. 5 is a flowchart showing another example of a process flow 500 that may be executed by a locker management server, such as the locker management server 104, to manage a food order. At operation 502, the locker management server receives a food order, for example, from a customer. At operation 504, the locker management server places the food order in a preparation queue. The position of the food order in the preparation queue may be selected based on an arrival time for the customer or other party picking up the food order. At operation 506, the locker management server may modify the preparation user interface provided to one or more preparers to indicate the received food order. In some examples, operation 506 occurs immediately after the food order is added to the preparation queue. In other examples, the operation 506 occurs when the received food order has received a designated position in the preparation queue (e.g., X orders from the end of the queue).

At operation 508, the locker management system determines whether to assign a food locker to the received order. The locker management system may assign a food locker, for example, if the arrival time for the food order is near. In other examples, the locker management system may assign a food locker when a geolocation received from the customer or other party indicates that the customer or other party is within a threshold distance of the food locker bank. If no locker is assigned at operation 508, the locker management server may continue, at operation 508, to determine whether to assign a food locker.

If the locker management server determines at operation 508 to assign a food locker or food lockers to the food order, the assignment may occur at operation 510. At operation 512, the locker management server may modify the preparer user interface to indicate the assigned food locker, for example, at an order element and/or locker element of the preparer user interface. The locker management server may also notify the customer or other party of the food locker or lockers where they are to pick-up the food order.

At operation 514, the locker management server receives an indication that food items making up the food order have been placed in the assigned food locker or food lockers. The indication can be or include, for example, an input provided by a preparer via the preparer user interface and/or a message received from the assigned food locker or lockers indicating the presence of the food item or items.

At operation 516, the locker management server determines that the customer or other party is present at or near the food locker bank. For example, the customer or other party may send a check-in message to the locker management server indicating their presence at the food locker bank. In another example, the customer or other party sends a geolocation signal to the locker management server indicating the location of the customer or other party. The locker management server may determine that the customer or other party is present at the food locker bank.

At operation 518, the locker management server sends a message to the assigned food locker or food lockers for the order requesting that the food lockers be unlocked. The food locker (e.g., the microcontroller thereof) may respond by sending a signal to disengage a lock or locks at the food locker. In some examples, the locker management server also indicates that the food locker should light a light to illuminate one or more locker compartments. In this way, the customer may be directed to the food locker or food lockers that are illuminated.

At operation 520, the locker management server determines if the locker has been emptied within an order pick-up period. For example, the customer or other party may be late or may decline to pick-up the food order. If this occurs, leaving the food item or items of the food order in the assigned food locker or lockers may cause the food to become sub-optimal and may occupy a food locker that could be used for other food orders. If the locker is not emptied during the order pick-up period, the locker management server executes an empty locker routine at operation 522. This may include, for example, modifying the preparer user interface to indicate that a preparer should remove the food item or items making up the food order from the assigned food locker or lockers. In some examples, the locker management server modifies the order element corresponding to the order and/or the locker element or elements corresponding to the food locker or lockers.

If the assigned food locker or lockers are emptied in the pick-up period at operation 520 or after the empty locker routine is executed at operation 522, the locker management server may release the assigned food locker or lockers for assignment to a next food order at operation 524.

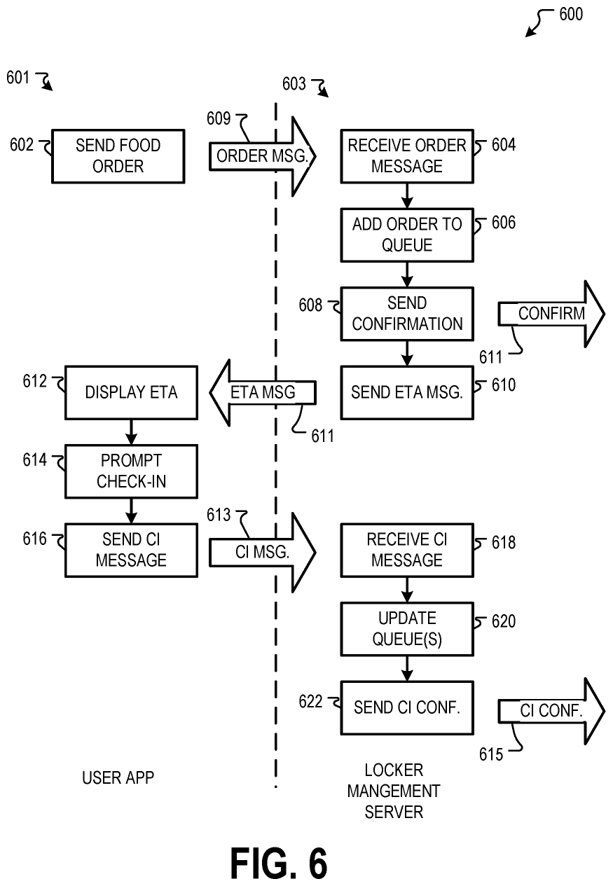

FIG. 6 is a flowchart showing one example of a process flow 600 that may be executed in a food locker environment to receive a food order. The process flow 600 includes two columns 601 and 603. The column 601 includes operations executed by a user application, such as the application 108A, 108B, 108N, executing at a customer's user computing device. The column 603 includes actions executed by a locker management server.

At operation 602, the user application sends a food order message 609 to the locker management server. The food order message 609 describes a food order made by a customer. In some examples, the user application is also configured to, for example, provide the customer with menu data describing food items that can be part of the food order.

At operation 604, the locker management server receives the food order message 609. At operation 606, the locker management server adds the food order described by the message 609 to a preparation queue. At operation 608, the locker management server sends a confirmation message 611 to a preparer computing device to confirm that the food order has been added to the preparation queue. In some examples, the confirmation message 611 is or comprises a user interface screen including an order element corresponding to the received food order. In some examples, the confirmation message 611 includes data about the food order that is utilized by a preparer computing device to update the preparer user interface.

At operation 608, the locker management server sends to the user application an estimated time of arrival (ETA) message 611. The ETA message 611 indicates an arrival time when the customer (or other party) should arrive to pick-up the order at the food locker bank. The user application displays the ETA indicated by the ETA message at operation 612. The ETA message may be provided via an API, via an SMS message, or by other suitable communication technique.

At operation 614, the user application may prompt the customer to check-in. The prompt at operation 614 may occur, for example, within a threshold time of the ETA. In some examples, the user application monitors a geolocation of the user computing device on which it executes and prompts the customer to check-in upon determining that the customer is at or near the food locker bank.

Upon being prompted, the customer or other party may check-in to the user application, for example, by selecting a check-in button on a user interface or by another suitable method. The user application may respond by sending a check-in message 613 to the locker management server at operation 616. The locker management server receives the check-in message 613 at operation 618. The locker management server updates the preparation queue at operation 620. This can include, for example, modifying the sequence of food orders in the queue based on the presence of the customer indicated by the check-in message 613. For example, if the food order is behind one or more other food orders for customers who have not yet checked in, the locker management server may move the food order up in the preparation queue.

At operation 622, the locker management server sends a check-in confirmation message 615, for example, to a preparer computing device. The check-in confirmation message may include an updated preparer user interface screen and/or may prompt the preparer computing device to update the preparer user interface. For example, the preparer user interface may be updated to indicate a food locker or lockers assigned to the food order, to indicate a change to the preparation queue from operation 620, to indicate that the customer for the food order has checked-in, and the like.

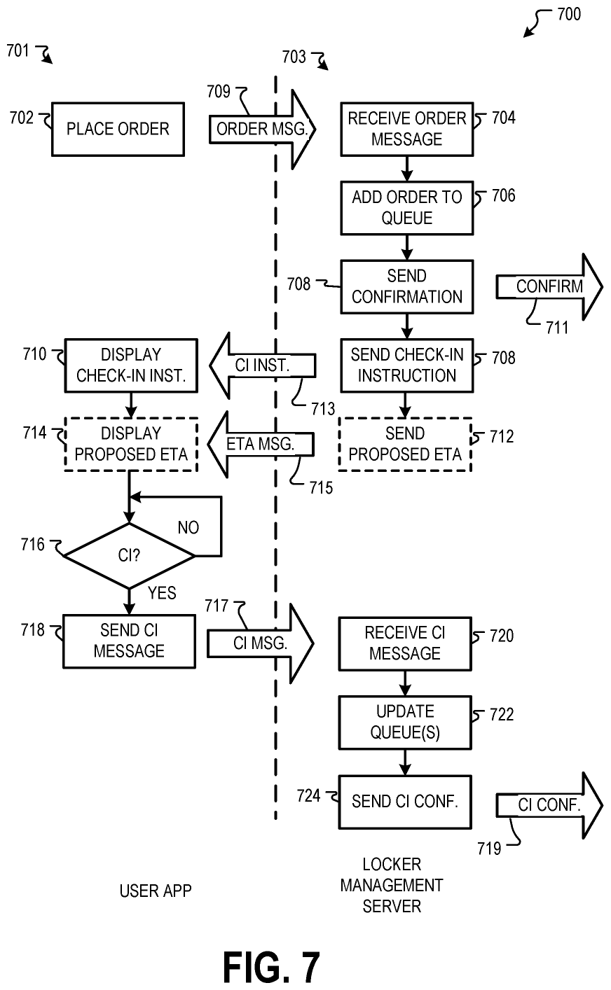

FIG. 7 is a flowchart showing one example of a process flow 700 that may be executed in a food locker environment to receive a food order according to a just-in-time preparation arrangement. The process flow 700 includes two columns 701 and 703. The column 701 includes operations executed by a user application, such as the application 108A, 108B, 108N, executing at a customer's user computing device. The column 703 includes actions executed by a locker management server.

At operation 702, the user application sends a food order message 709 to the locker management server. The food order message 709 describes a food order made by a customer. In some examples, the user application is also configured to, for example, provide the customer with menu data describing food items that can be part of the food order.

At operation 704, the locker management server receives the food order message 709. At operation 706, the locker management server adds the food order described by the message 709 to a preparation queue. At operation 708, the locker management server sends a confirmation message 711 to a preparer computing device to confirm that the food order has been added to the preparation queue. In some examples, the confirmation message 711 is or comprises a user interface screen including an order element corresponding to the received food order. In some examples, the confirmation message 711 includes data about the food order that is utilized by a preparer computing device to update the preparer user interface.

At operation 708, the locker management server sends to the user application a check-in instruction message 711. The check-in instruction message 711 provides instructions for the customer to check-in when present at the food locker bank. At optional operation 712, the locker management server sends a proposed ETA message 715 to the user application. The proposed ETA message 715 indicates a proposed ETA for the food order. For example, the locker management server may assign the food order the preparation queue based on the proposed eta. The user application receives the proposed ETA message and displays the proposed ETA to the customer at operation 714.

At operation 716, the user application wait for the customer to check-in. The customer may check-in to the user application, for example, by selecting a check-in button on a user interface or by another suitable method. The user application may respond by sending a check-in message 717 to the locker management server at operation 718.

The locker management server receives the check-in message 717 at operation 720. The locker management server updates the preparation queue at operation 722. This can include, for example, modifying the sequence of food orders in the queue based on the presence of the customer indicated by the check-in message 717. For example, if the food order is behind one or more other food orders for customers who have not yet checked in, the locker management server may move the food order up in the preparation queue.

At operation 724, the locker management server sends a check-in confirmation message 715, for example, to a preparer computing device. The check-in confirmation message may include an updated preparer user interface screen and/or may prompt the preparer computing device to update the preparer user interface. For example, the preparer user interface may be updated to indicate a food locker or lockers assigned to the food order, to indicate a change to the preparation queue from operation 720, to indicate that the customer for the food order has checked-in, and the like.

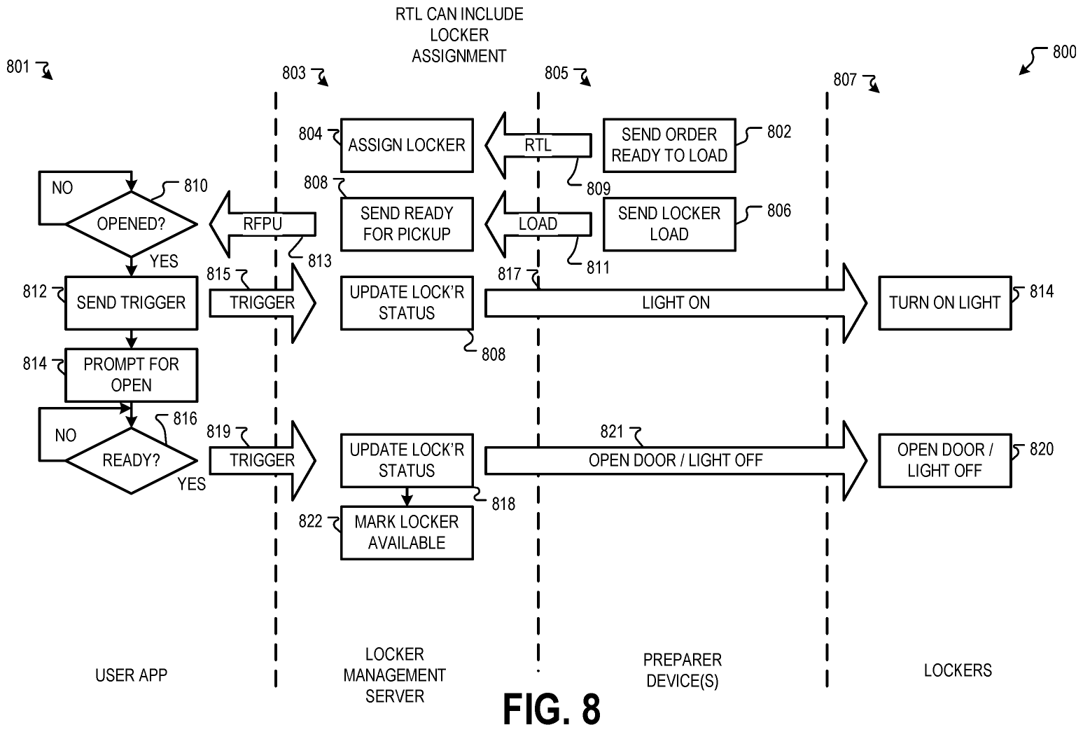

FIG. 8 is a flowchart showing one example of a process flow 800 that may be executed in a food locker environment to fulfill a food order. For example, the process flow 800 may be executed for a food order received as described in the example of FIG. 6 and or as described in the example of FIG. 7. The process flow 800 includes four columns 801, 803, 805, 807. The column 801 includes actions that may be executed by a user application such as the application 108A, 108B, 108N executing at a customer's user computing device. In some examples, the operations in the column 801 are executed by an application executing at a user computing device of another party who will pick-up the food order and deliver it to the customer. The column 803 includes actions executed by a locker management server. The column 805 includes actions executed by one or more preparer computing devices, such as one or more of the preparer computing devices 116A, 116N. The column 807 includes operations executed by one or more food lockers.

Prior to execution of the process flow 800, a food order may have been received and the customer (or other party picking up the food order) may have checked-in at the food locker bank location, for example, in the manner described with respect to FIG. 6 or in the manner described with respect to FIG. 7. For example, the preparer computing device may have been provided with a check-in confirmation that includes an updated preparer interface screen and/or includes data for generating an updated preparer interface screen indicating the food order in the preparation queue.

When a preparer completes the food items for the food order, the preparer provides a “ready to load” via the preparer user interface. The preparer computing device, at operation 802, sends a ready to load message 809 to the locker management server. The locker management server receives the ready to load message 809 and assigns one or more food lockers to the food order at operation 804. The assigned food locker or lockers may include a food locker at the food locker bank that is current available. The locker management server may provide the preparer with an indication of the selected food locker or lockers, for example, by updating the preparer user interface.

The preparer may load the food items making up the food order into the assigned food locker or lockers and provide a confirmation that the food order has been loaded to the food locker or lockers via the preparer user interface. The preparer computing device may respond by sending a locker loaded message 811 to the locker management server at operation 806.

The locker management server receives the locker loaded message 811 and, at operation 808, sends the user application a ready for pickup message 813. The user application may wait at operation 810 until the customer or other party opens the ready for pickup message 813. The ready for pickup message 813 may include an indication of the food locker or food lockers assigned the food order. When the customer or other party opens the ready for pickup message 813, the user application, at operation 810, sends a first trigger 815 to the locker management server. Responsive to receiving the first trigger 815, the locker management server updates the assigned locker or lockers, for example, by sending, at operation 812 a lights on message 817 to the locker. Upon receiving the lights on message 817, the assigned food locker turns on its light at operation 814. As described herein, turning on the lights at the food locker may help the customer or other party locate the food locker containing their order.

At operation 814, the user application prompts the customer or other user to indicate when they are ready to open the door of the food locker or lockers including the food items of the food order. The user application waits until the customer or other party is ready at operation 816. When the customer or other party is ready, the user application sends a second trigger 819 to the locker management server. The locker management server receives the second trigger at operation 819 and updates the status of the assigned food locker or lockers by sending an open door message 821. The assigned food locker or lockers receives the open door message 821 and releases the lock at operation 820 to allow the customer or other user to open one or more doors of the food locker to remove the food items therein. In some examples, the open door message 821 also instructs the food locker to turn off its light, for example, before the door is unlocked and/or after the door is closed by the customer after removing the food items. At operation 822, the locker management server marks the food locker or lockers assigned to the order available for the next food order.

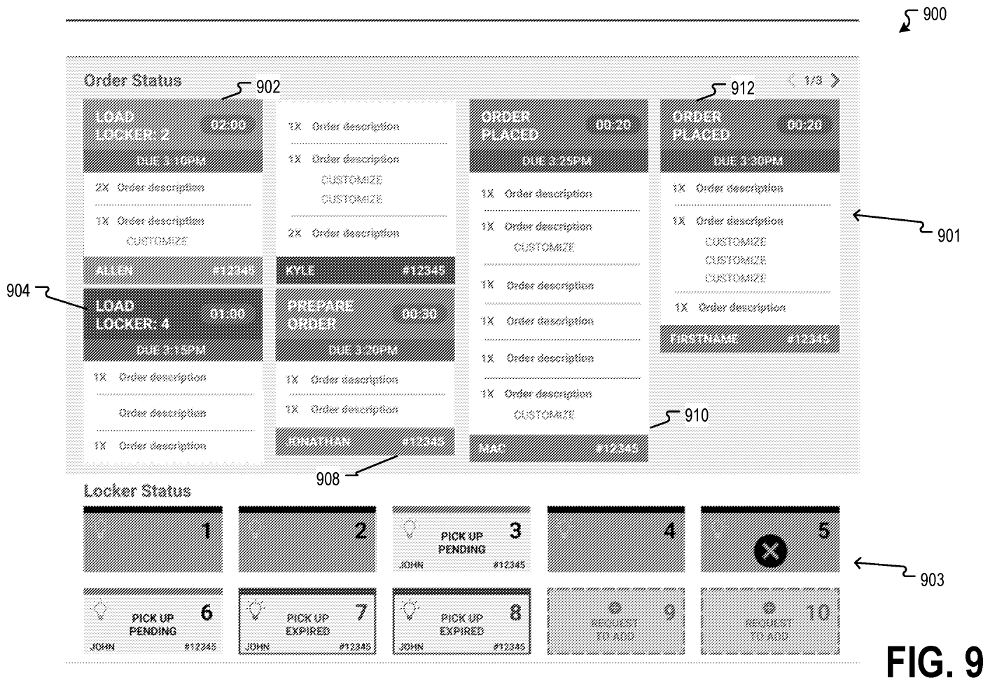

FIG. 9 is a diagram showing one example of a user interface screen 900 that may be provided with the provider user interface. The screen 900 includes an order status field 901 and a locker status field 903. The order status field 901 comprises order elements 902, 904, 906, 908, 910. The order elements 902, 904, 906, 908, 910 include data describing food orders including, for example, the food items included in the food order including a quantity of each, a number or other identifier of the food order, a name of the customer or other party who is to pick up the food order, and the estimated arrival time of the customer for each order (indicated as a time when the food order is “due”).

The order elements 902, 904, 906, 908, 910 also comprise status information about the food order. For example, order elements 910 and 912 may represent orders that are not yet part of the preparation queue and/or are not near the end of the preparation queue. The order elements 910, 912 indicate that their respective food orders have been placed. Order element 908 indicates that the status of its food order is ready to prepare. Order elements 902 and 904 indicate that the status of their food orders is that the preparer should load the food order to a food locker indicated at the elements 902, 904. For example, the food order for order element 904 is to be loaded to locker 4 and the food order for order element 902 is to be loaded to locker 2.

In some examples, the coloring of the order elements indicates the urgency of the corresponding food orders. For example, the order element 902 may have a yellow coloring for some or all of the order element 902 to indicate that it is more urgent than the other orders. Order elements 904 and 908 have a green coloring, which may indicate that those elements are ready for preparation but not as urgent as the yellow element 902. In some examples, different colors may be used to indicate different levels of urgency.

The locker status field 903 includes locker icons labeled 1 through 9 and two add locker buttons labeled 9 and 10. The locker icons 1-9 indicate whether the light is on at the respective lockers. For example, the food lockers corresponding to locker elements 3, 6, 7, and 8 may have their lights on. The food lockers corresponding to locker elements 3 and 6 may include food items awaiting pickup. The food lockers corresponding to locker elements 7 and 8 may include food items that the preparer is to remove for having been present at the food lockers for longer than the pick-up period. The color of these locker elements 7 and 8 and the text “Pick Up Expired” may indicate to the preparer that the food items in the corresponding food lockers should be removed.

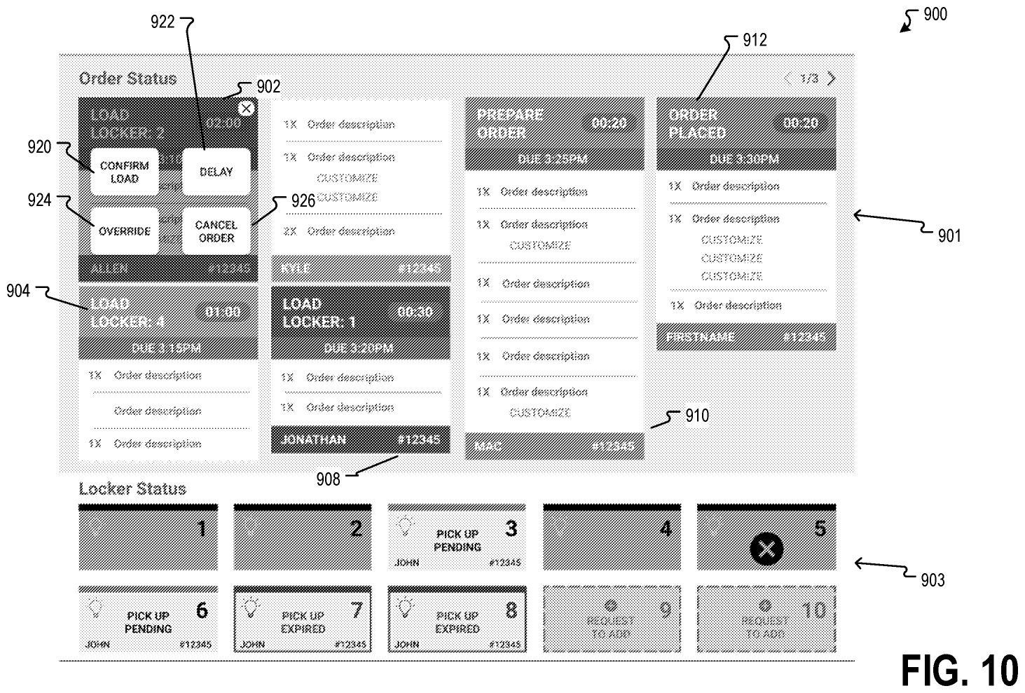

FIG. 10 is a diagram showing example of the user interface screen 900 of FIG. 9 at a later point in time than what is depicted in FIG. 9. For example, in FIG. 10, the order element 904, which was previously described as being colored green, may be colored yellow to indicate that urgency of the food order associated with the order element 904 has increased. Also, the order element 902, which was previously described as being colored yellow, may be colored red in FIG. 10 to indicate that the associated food order is most urgent. A preparer has also selected the order element 902 to provide the locker management server with additional information about the associated food order. When the preparer selects the order element 902 a number of buttons 920, 922, 924, 926, 928 are displayed. The preparer may select the button confirm load button 920 to indicate to the locker management server that the associated food order has been provided at a food locker.

The preparer may select the override button 924, for example, to manually override the food locker assigned to the food order by the locker management server. For example, the preparer may override the food locker assignment of the locker management server for various reasons including, for example, if the assigned locker is already in use, if the assigned food locker is malfunctioning or in need of cleaning, if the assigned food locker does have an appropriately heated or cooled compartment, if the food items for the food order do not fit in the assigned food locker or lockers, etc. If the preparer selects the override button 924, the preparer may provide an indication of the food locker that the food items making up the food order are paced in. The locker management server may inform the customer or other party picking up the order of the new assigned food locker or lockers, for example, by sending an appropriate message to the user computing device and/or user application as described herein.

The delay button 922 may be selected if the associated food order is delayed. When the preparer selects the delay button, an indication of the delay may be provided to the customer and/or other party picking up the order. In some examples, the locker management server may respond to the delay button by releasing the food locker or lockers and, after waiting for a delay period, assigning a new food locker or lockers for the food order. The delay period, in some examples, is provided by the preparer via the preparer user interface. The preparer may select a cancel order button 926 to cancel the associated food order.

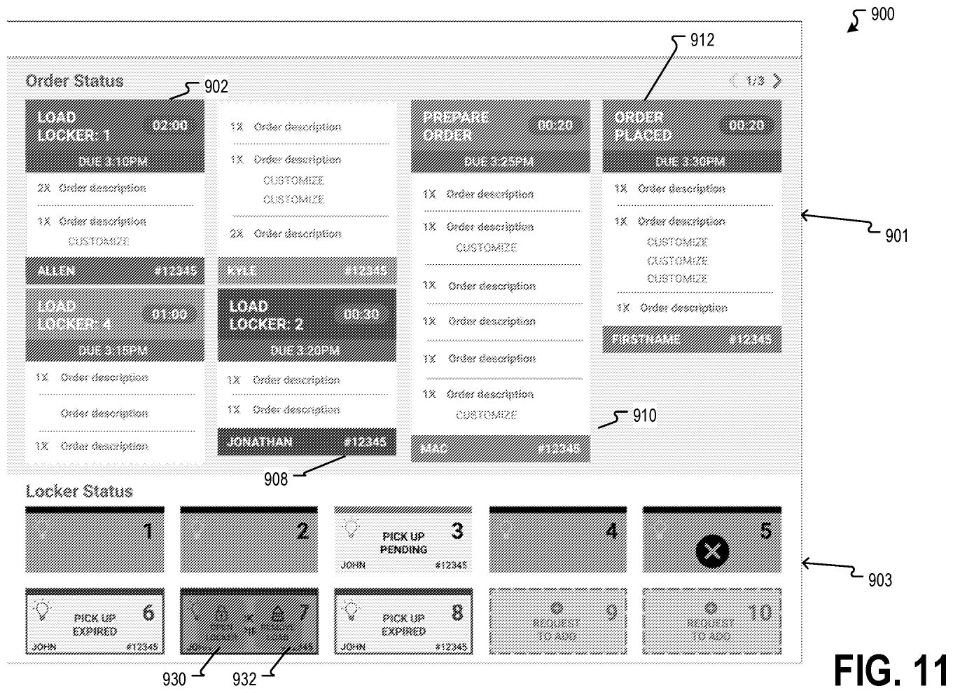

FIG. 11 is a diagram showing an example of the user interface 900 of FIG. 9 and illustrating an empty locker routine. In the example of FIG. 11, the locker element 7 corresponds to a food locker that includes food items of a food order that has been in the food locker for longer than a pick-up period. When the locker management server determines that food items have been in a food locker for longer than the pick-up period, it may modify the locker elements 6, 7, 8 corresponding to the affected food lockers, as shown in FIG. 11, to indicate that the corresponding pick-up has expired. When the preparer may select the corresponding locker element to unload the food locker. When the preparer selects the locker element, the preparer user interface may display buttons 930. When the preparer selects the open locker button 930, the locker management server may instruct the corresponding food locker to release its lock to open its door. After the preparer has removed the food items in the food locker, he or she may select the remove load button 932. In response, the locker management server may mark the food locker available for a next food order.

FIG. 12 is a diagram showing another example variation of the environment 100. In the example of FIG. 12, a food locker bank includes two sub-banks 1202, 1204. In this example, food lockers of the sub-bank 1202 are used for pickup by the customers 105A, 105B, 105N who place an order, as described herein. Food lockers in the sub-bank 1204 are used for food orders to be picked-up and delivered by third parties 1205A, 1205B, 1205N as described herein. In some examples, the sub-banks 1202, 1204 are placed at different physical locations. For example, the sub-bank 1202 for customer pick-up can be placed at a location frequented by customers such as, for example, near a counter or dining area. The sub-bank 1204 for third-party pickup may be placed, for example, at a building exterior, vestibule, or other location suitable for third-party pick-up. Also, although FIG. 12 shows sub-banks 1202 and 1204 dedicated to customer pickup (sub-bank 1202) and third party pick-up (sub-back 1204), in some examples customer and third party pick-up can use a single unitary locker bank.

In the example of FIG. 12, for orders where the customers 105A, 105B, 105N pick-up completed food orders at the sub-bank 1202, the locker management server may handle food orders in a manners similar to that described with respect to FIG. 1. For example, upon receiving a food order from a customer 105A, 105B, 105N, the locker management server 104 may assign the food order to a preparation queue and interact with the preparers 118A, 118B, 118N and customer 105A, 105B, 105N as described herein.

A food order for third-party pickup may be made by a customer 105A, 105B, 105N via the application 108A, 108B, 108N. For example, the application 108A, 108B, 108N may provide the customer 105A, 105B, 105N with an option to select a fulfillment option (e.g., pick-up or delivery). If the customer selects delivery, the locker management server 104 may assign the food order to the preparation queue as described herein. The locker management server 104 may additionally communicate with a third party 1205A, 1205B, 1205N who is to pick-up and delivery the food order. The third party 1205A, 1205B, 1205N utilizes a user computing device 1206A, 1206B, 1206N, which may be similar to the user computing devices 106A, 106B, 106N. User computing devices 1206A, 1206B, 1206N may execute a delivery application 1208A, 1208B, 1208N. The delivery applications 1208A, 1208B, 1208N may communicate with the locker management server, for example, via an API or other suitable method, as described herein.

The locker management server 104 may provide the delivery application 1208A, 1208B, 1208N with an indication of an arrival time and an indication of the food locker or food lockers (e.g., at the sub-bank 1204) where the food items will be placed. The third party 1205A, 1205B, 1205N may utilize the delivery application 1208A, 1208B, 1208N to check-in and retrieve the food order from the one or more food lockers, for example, in a way similar to the way that the customer 105A, 105B, 105N would check-in and pick-up an order for customer pick-up as described herein. For example, when the third party 1205A, 1205B, 1205N arrives at the locker bank, the third party 1205A, 1205B, 1205N may send a check-in message, as described with respect to FIGS. 6 and 7, and/or a locker open trigger, similar to the trigger 815 of FIG. 8. In response the locker management server 104 may illuminate the food locker or lockers, unlock the food locker or lockers, or perform other actions described herein to facilitate the removal of the food items by the third party 1205A, 1205B, 1205N. Upon retrieving the food items, the third party 1205A, 1205B, 1025N may deliver the food items to the customer 105A, 105B, 105N who placed the order.

### EXAMPLES

Example 1 is a food locker system comprising: at least one processor programmed to perform operations comprising: receiving a first food order from a user computing device the first food order describing a first food item for pickup; adding the first food order to a preparation queue;causing a preparer computing device to display a preparer user interface screen, the preparer user interface screen comprising a plurality of order elements including a first order element corresponding to the first food order; receiving, from the preparer user device, an indication that the first food order has been placed in a first food locker of a food locker bank; sending, to the user computing device, an indication that the first food order has been placed in the first food locker; and instructing the first food locker to unlock a first food locker lock.

In Example 2, the subject matter of Example 1 optionally includes the operations further comprising responsive to receiving the indication that the first food order has been placed in the first food locker, instructing the first food locker to illuminate a first food locker compartment of the first food locker.

In Example 3, the subject matter of any one or more of Examples 1-2 optionally includes the operations further comprising: receiving, from the preparer user device, an indication that the first food item order is ready; and causing the preparer user computing device to modify the first order element to indicate the first food locker.

In Example 4, the subject matter of any one or more of Examples 1-3 optionally includes the operations further comprising: accessing first preparation condition data describing the first food order; receiving a second food order from a second user computing device, the second food order being described by second preparation condition data; and selecting the first food order for adding to the preparation queue using the first preparation condition data and the second preparation condition data.

In Example 5, the subject matter of any one or more of Examples 1-4 optionally includes the receiving of the first food order comprising a first arrival time for the first food order.

In Example 6, the subject matter of any one or more of Examples 1-5 optionally includes the operations further comprising: accessing a first arrival time for the first food order; receiving a second food order from a second user computing device, the second food order being described by a second arrival time; and selecting the first food order for adding to the preparation queue using the first arrival time and the second arrival time.

In Example 7, the subject matter of Example 6 optionally includes the second food order being received before the first food order is received.

In Example 8, the subject matter of any one or more of Examples 1-7 optionally includes the preparer user interface screen further comprising a plurality of locker elements, a first locker element of the plurality of locker elements corresponding to the first locker.

In Example 9, the subject matter of any one or more of Examples 1-8 optionally includes the operations further comprising receiving a first check-in message from the first user computing device, the first check-in message indicating that a user of the first user computing device is ready to pick up the first food order.

In Example 10, the subject matter of Example 9 optionally includes the adding of the first food order to the preparation queue being responsive to the first check-in message.

In Example 11, the subject matter of any one or more of Examples 9-10 optionally includes the instructing the first food locker to unlock a first food locker lock being responsive to the first check-in message.

In Example 12, the subject matter of any one or more of Examples 1-11 optionally includes the operations further comprising: receiving a second food order from a user computing device the second food order describing a second food item for pickup; receiving, from the preparer user device, an indication that the second food order has been placed in a second food locker of the food locker bank; determining that more than a threshold time period has passed since the second food order has been placed in the second food locker; responsive to determining that more than the threshold time period has passed since the second food order has been placed in the second food locker, modifying the preparer user interface screen to indicate that a pick-up period of the second food order has expired; and receiving, from the preparer computing device, an indication that the second food order has been cleared from the second food locker.

In Example 13, the subject matter of any one or more of Examples 1-12

optionally includes the food locker bank comprising a first locker sub-bank at a first location and a second locker sub-bank at a second location, the first locker sub-bank comprising the first food locker, the operations further comprising: determining that the first food order is for customer pick-up; and responsive to determining that the first food order is for customer pick-up, selecting the first food locker for the first food order.

In Example 14, the subject matter of Example 13 optionally includes the operations further comprising: determining that a second food order received from a second user computing device is for third-party pickup; and responsive to determining that the second food order received from a second user computing device is for third-party pickup, selecting for the second food order a second locker of the second locker sub-bank.

Example 15 is a method of operating a food locker bank, comprising: receiving a first food order from a user computing device the first food order describing a first food item for pickup; adding the first food order to a preparation queue; causing a preparer computing device to display a preparer user interface screen, the preparer user interface screen comprising a plurality of order elements including a first order element corresponding to the first food order; receiving, from the preparer user device, an indication that the first food order has been placed in a first food locker of the food locker bank; sending, to the user computing device, an indication that the first food order has been placed in the first food locker; and instructing the first food locker to unlock a first food locker lock.

In Example 16, the subject matter of Example 15 optionally includes responsive to receiving the indication that the first food order has been placed in the first food locker, instructing the first food locker to illuminate a first food locker compartment of the first food locker.

In Example 17, the subject matter of any one or more of Examples 15-16 optionally includes receiving, from the preparer user device, an indication that the first food item order is ready; and causing the preparer user computing device to modify the first order element to indicate the first food locker.

In Example 18, the subject matter of any one or more of Examples 15-17 optionally includes accessing first preparation condition data describing the first food order; receiving a second food order from a second user computing device, the second food order being described by second preparation condition data; and selecting the first food order for adding to the preparation queue using the first preparation condition data and the second preparation condition data.

In Example 19, the subject matter of any one or more of Examples 15-18 optionally includes the receiving of the first food order comprising a first arrival time for the first food order.

In Example 20, the subject matter of any one or more of Examples 15-19 optionally includes accessing a first arrival time for the first food order; receiving a second food order from a second user computing device, the second food order being described by a second arrival time; and selecting the first food order for adding to the preparation queue using the first arrival time and the second arrival time.

In Example 21, the subject matter of Example 20 optionally includes the second food order being received before the first food order is received.

In Example 22, the subject matter of any one or more of Examples 15-21 optionally includes the preparer user interface screen further comprising a plurality of locker elements, a first locker element of the plurality of locker elements corresponding to the first locker.

In Example 23, the subject matter of any one or more of Examples 15-22 optionally includes receiving a first check-in message from the first user computing device, the first check-in message indicating that a user of the first user computing device is ready to pick up the first food order.

In Example 24, the subject matter of Example 23 optionally includes the adding of the first food order to the preparation queue being responsive to the first check-in message.

In Example 25, the subject matter of any one or more of Examples 23-24 optionally includes the instructing the first food locker to unlock a first food locker lock being responsive to the first check-in message.

In Example 26, the subject matter of any one or more of Examples 15-25 optionally includes receiving a second food order from a user computing device the second food order describing a second food item for pickup; receiving, from the preparer user device, an indication that the second food order has been placed in a second food locker of the food locker bank; determining that more than a threshold time period has passed since the second food order has been placed in the second food locker; responsive to determining that more than the threshold time period has passed since the second food order has been placed in the second food locker, modifying the preparer user interface screen to indicate that a pick-up period of the second food order has expired; and receiving, from the preparer computing device, an indication that the second food order has been cleared from the second food locker.

In Example 27, the subject matter of any one or more of Examples 15-26 optionally includes the food locker bank comprising a first locker sub-bank at a first location and a second locker sub-bank at a second location, the first locker sub-bank comprising the first food locker, further comprising: determining that the first food order is for customer pick-up; and responsive to determining that the first food order is for customer pick-up, selecting the first food locker for the first food order.

In Example 28, the subject matter of Example 27 optionally includes determining that a second food order received from a second user computing device is for third-party pickup; and responsive to determining that the second food order received from a second user computing device is for third-party pickup, selecting for the second food order a second locker of the second locker sub-bank.

Example 29 is a non-transitory machine-readable medium comprising instructions thereon that, when executed by at least one processor, causes the at least one processor to perform operations comprising: receiving a first food order from a user computing device the first food order describing a first food item for pickup; adding the first food order to a preparation queue; causing a preparer computing device to display a preparer user interface screen, the preparer user interface screen comprising a plurality of order elements including a first order element corresponding to the first food order; receiving, from the preparer user device, an indication that the first food order has been placed in a first food locker of a food locker bank; sending, to the user computing device, an indication that the first food order has been placed in the first food locker; and instructing the first food locker to unlock a first food locker lock.

In Example 30, the subject matter of Example 29 optionally includes the operations further comprising responsive to receiving the indication that the first food order has been placed in the first food locker, instructing the first food locker to illuminate a first food locker compartment of the first food locker.

In Example 31, the subject matter of any one or more of Examples 29-30 optionally includes the operations further comprising: receiving, from the preparer user device, an indication that the first food item order is ready; and causing the preparer user computing device to modify the first order element to indicate the first food locker.

In Example 32, the subject matter of any one or more of Examples 29-31 optionally includes the operations further comprising: accessing first preparation condition data describing the first food order; receiving a second food order from a second user computing device, the second food order being described by second preparation condition data; and selecting the first food order for adding to the preparation queue using the first preparation condition data and the second preparation condition data.

In Example 33, the subject matter of any one or more of Examples 29-32 optionally includes the receiving of the first food order comprising a first arrival time for the first food order.

In Example 34, the subject matter of any one or more of Examples 29-33 optionally includes the operations further comprising: accessing a first arrival time for the first food order; receiving a second food order from a second user computing device, the second food order being described by a second arrival time; and selecting the first food order for adding to the preparation queue using the first arrival time and the second arrival time.

In Example 35, the subject matter of Example 34 optionally includes the second food order being received before the first food order is received.

In Example 36, the subject matter of any one or more of Examples 29-35 optionally includes the preparer user interface screen the operations further comprising a plurality of locker elements, a first locker element of the plurality of locker elements corresponding to the first locker.

In Example 37, the subject matter of any one or more of Examples 29-36 optionally includes the operations further comprising receiving a first check-in message from the first user computing device, the first check-in message indicating that a user of the first user computing device is ready to pick up the first food order.

In Example 38, the subject matter of Example 37 optionally includes the adding of the first food order to the preparation queue being responsive to the first check-in message.

In Example 39, the subject matter of any one or more of Examples 37-38 optionally includes the instructing the first food locker to unlock a first food locker lock being responsive to the first check-in message.

In Example 40, the subject matter of any one or more of Examples 29-39 optionally includes the operations further comprising: receiving a second food order from a user computing device the second food order describing a second food item for pickup; receiving, from the preparer user device, an indication that the second food order has been placed in a second food locker of the food locker bank; determining that more than a threshold time period has passed since the second food order has been placed in the second food locker; responsive to determining that more than the threshold time period has passed since the second food order has been placed in the second food locker, modifying the preparer user interface screen to indicate that a pick-up period of the second food order has expired; and receiving, from the preparer computing device, an indication that the second food order has been cleared from the second food locker.

In Example 41, the subject matter of any one or more of Examples 29-40 optionally includes the food locker bank comprising a first locker sub-bank at a first location and a second locker sub-bank at a second location, the first locker sub-bank comprising the first food locker, the operations further comprising: determining that the first food order is for customer pick-up; and responsive to determining that the first food order is for customer pick-up, selecting the first food locker for the first food order.

In Example 42, the subject matter of Example 41 optionally includes the operations further comprising: determining that a second food order received from a second user computing device is for third-party pickup; and responsive to determining that the second food order received from a second user computing device is for third-party pickup, selecting for the second food order a second locker of the second locker sub-bank.

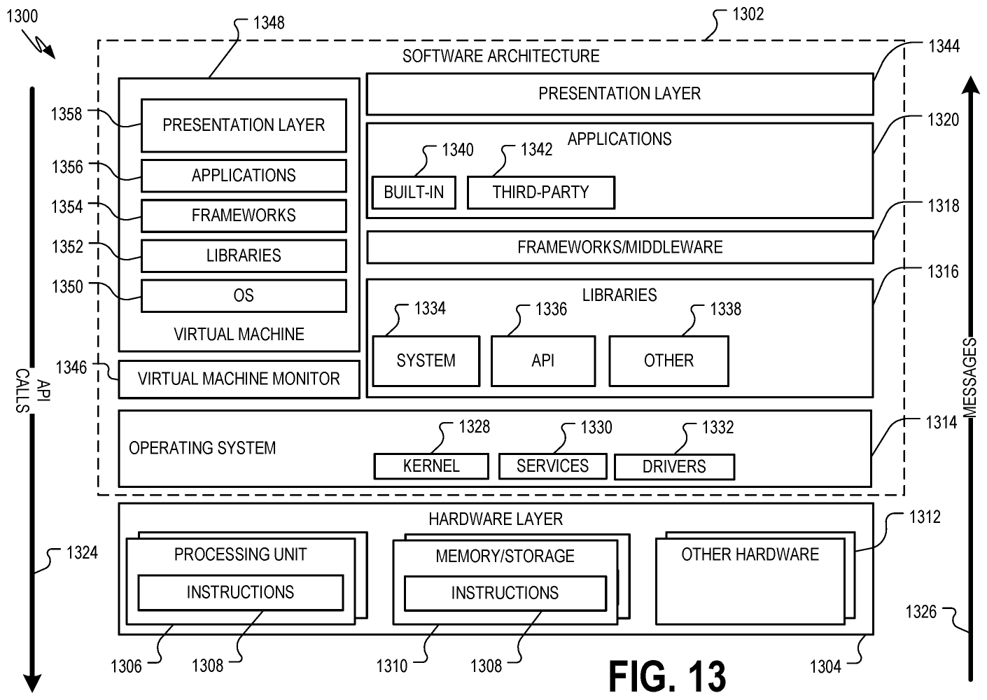

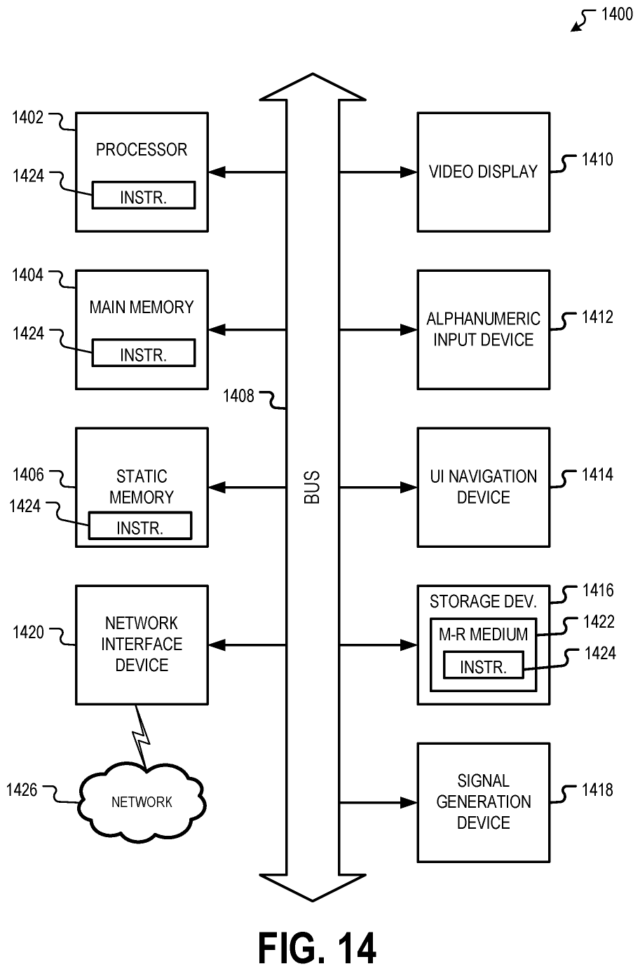

FIG. 13 is a block diagram 1300 showing one example of a software architecture 1302 for a computing device. The architecture 1302 may be used in conjunction with various hardware architectures, for example, as described herein. FIG. 13 is merely a non-limiting example of a software architecture and many other architectures may be implemented to facilitate the functionality described herein. A representative hardware layer 1304 is illustrated and can represent, for example, any of the above referenced computing devices. In some examples, the hardware layer 1304 may be implemented according to the architecture of the computer system of FIG. 13.

The representative hardware layer 1304 comprises one or more processing units 1306 having associated executable instructions 1308. Executable instructions 1308 represent the executable instructions of the software architecture 1302, including implementation of the methods, modules, subsystems, and components, and so forth described herein and may also include memory and/or storage modules 1310, which also have executable instructions 1308. Hardware layer 1304 may also comprise other hardware as indicated by other hardware 1312 which represents any other hardware of the hardware layer 1304, such as the other hardware illustrated as part of the architecture 1302.

In the example architecture of FIG. 13, the software architecture 1302 may be conceptualized as a stack of layers where each layer provides particular functionality. For example, the software architecture 1302 may include layers such as an operating system 1314, libraries 1316, frameworks/middleware 1318, applications 1320, and presentation layer 1344. Operationally, the applications 1320 and/or other components within the layers may invoke API calls 1324 through the software stack and access a response, returned values, and so forth illustrated as messages 1326 in response to the API calls 1324. The layers illustrated are representative in nature and not all software architectures have all layers. For example, some mobile or special purpose operating systems may not provide a frameworks/middleware layer 1318, while others may provide such a layer. Other software architectures may include additional or different layers.

The operating system 1314 may manage hardware resources and provide common services. The operating system 1314 may include, for example, a kernel 1328, services 1330, and drivers 1332. The kernel 1328 may act as an abstraction layer between the hardware and the other software layers. For example, the kernel 1328 may be responsible for memory management, processor management (e.g., scheduling), component management, networking, security settings, and so on. The services 1330 may provide other common services for the other software layers. In some examples, the services 1330 include an interrupt service. The interrupt service may detect the receipt of an interrupt and, in response, cause the architecture 1302 to pause its current processing and execute an interrupt service routine (ISR) when an interrupt is accessed.

The drivers 1332 may be responsible for controlling or interfacing with the underlying hardware. For instance, the drivers 1332 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1316 may provide a common infrastructure that may be utilized by the applications 1320 and/or other components and/or layers. The libraries 1316 typically provide functionality that allows other software modules to perform tasks in an easier fashion than to interface directly with the underlying operating system 1314 functionality (e.g., kernel 1328, services 1330 and/or drivers 1332). The libraries 1316 may include system 1334 libraries (e.g., C standard library) that may provide functions such as memory allocation functions, string manipulation functions, mathematic functions, and the like. In addition, the libraries 1316 may include API libraries 1336 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1316 may also include a wide variety of other libraries 1338 to provide many other APIs to the applications 1320 and other software components/modules.

The frameworks 1318 (also sometimes referred to as middleware) may provide a higher-level common infrastructure that may be utilized by the applications 1320 and/or other software components/modules. For example, the frameworks 1318 may provide various graphic user interface (GUI) functions, high-level resource management, high-level location services, and so forth. The frameworks 1318 may provide a broad spectrum of other APIs that may be utilized by the applications 1320 and/or other software components/modules, some of which may be specific to a particular operating system or platform.

The applications 1320 includes built-in applications 1340 and/or third party applications 1342. Examples of representative built-in applications 1340 may include, but are not limited to, a contacts application, a browser application, a book reader application, a location application, a media application, a messaging application, and/or a game application. Third party applications 1342 may include any of the built in applications as well as a broad assortment of other applications. In a specific example, the third party application 1342 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third party application 1342 may invoke the API calls 1324 provided by the mobile operating system such as operating system 1314 to facilitate functionality described herein.

The applications 1320 may utilize built in operating system functions (e.g., kernel 1328, services 1330 and/or drivers 1332), libraries (e.g., system 1334, APIs 1336, and other libraries 1338), and frameworks/middleware 1318 to create user interfaces to interact with users of the system. Alternatively, or additionally, in some systems interactions with a user may occur through a presentation layer, such as presentation layer 1344. In these systems, the application/module “logic” can be separated from the aspects of the application/module that interact with a user.

Some software architectures utilize virtual machines. In the example of FIG. 13, this is illustrated by virtual machine 1348. A virtual machine creates a software environment where applications/modules can execute as if they were executing on a hardware computing device. A virtual machine is hosted by a host operating system (operating system 1314) and typically, although not always, has a virtual machine monitor 1346, which manages the operation of the virtual machine as well as the interface with the host operating system (i.e., operating system 1314). A software architecture executes within the virtual machine such as an operating system 1350, libraries 1352, frameworks/middleware 1354, applications 1356 and/or presentation layer 1358. These layers of software architecture executing within the virtual machine 1348 can be the same as corresponding layers previously described or may be different.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### ELECTRONIC APPARATUS AND SYSTEM

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### EXAMPLE MACHINE ARCHITECTURE AND MACHINE-READABLE MEDIUM

FIG. 14 is a block diagram of a machine in the example form of a computer system 1400 within which instructions 1424 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU), or both), a main memory 1404, and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard or a touch-sensitive display screen), a user interface (UI) navigation (or cursor control) device 1414 (e.g., a mouse), a disk drive unit 1416, a signal generation device 1418 (e.g., a speaker), and a network interface device 1420.

### MACHINE-READABLE MEDIUM

The disk drive unit 1416 includes a machine-readable medium 1422 on which is stored one or more sets of data structures and instructions 1424 (e.g., software) embodying or utilized by any one or more of the methodologies or functions described herein. The instructions 1424 may also reside, completely or at least partially, within the main memory 1404 and/or within the processor 1402 during execution thereof by the computer system 1400, with the main memory 1404 and the processor 1402 also constituting machine-readable media 1422.

While the machine-readable medium 1422 is shown in an example embodiment to be a single medium, the term “machine-readable medium” may include a single medium or multiple media (e.g., a centralized or distributed database, and/or associated caches and servers) that store the one or more instructions 1424 or data structures. The term “machine-readable medium” shall also be taken to include any tangible medium that is capable of storing, encoding. or carrying instructions 1424 for execution by the machine and that cause the machine to perform any one or more of the methodologies of the present disclosure, or that is capable of storing, encoding, or carrying data structures utilized by or associated with such instructions 1424. The term “machine-readable medium” shall accordingly be taken to include, but not be limited to, solid-state memories, and optical and magnetic media. Specific examples of machine-readable media 1422 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### TRANSMISSION MEDIUM

The instructions 1424 may further be transmitted or received over a communications network 1426 using a transmission medium. The instructions 1424 may be transmitted using the network interface device 1420 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1424 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A food locker system comprising:
at least one processor programmed to perform operations comprising:
receiving a first food order from a user computing device the first food order describing a first food item for pickup;
adding the first food order to a preparation queue;
causing a preparer computing device to display a preparer user interface screen, the preparer user interface screen comprising a plurality of order elements including a first order element corresponding to the first food order;
receiving, from the preparer user device, an indication that the first food order has been placed in a first food locker of a food locker bank;
sending, to the user computing device, an indication that the first food order has been placed in the first food locker; and
instructing the first food locker to unlock a first food locker lock.

2. The food locker system of claim 1, the operations further comprising responsive to receiving the indication that the first food order has been placed in the first food locker, instructing the first food locker to illuminate a first food locker compartment of the first food locker.

3. The food locker system of claim 1, the operations further comprising:
receiving, from the preparer user device, an indication that the first food item order is ready; and
causing the preparer user computing device to modify the first order element to indicate the first food locker.

4. The food locker system of claim 1, the operations further comprising:
accessing first preparation condition data describing the first food order;
receiving a second food order from a second user computing device, the second food order being described by second preparation condition data; and
selecting the first food order for adding to the preparation queue using the first preparation condition data and the second preparation condition data.

5. (canceled)

6. The food locker system of claim 1, the operations further comprising:
accessing a first arrival time for the first food order;
receiving a second food order from a second user computing device, the second food order being described by a second arrival time; and
selecting the first food order for adding to the preparation queue using the first arrival time and the second arrival time.

7. The food locker system of claim 6, the second food order being received before the first food order is received.

8. The food locker system of claim 1, the preparer user interface screen further comprising a plurality of locker elements, a first locker element of the plurality of locker elements corresponding to the first locker.

9. The food locker system of claim 1, the operations further comprising receiving a first check-in message from the first user computing device, the first check-in message indicating that a user of the first user computing device is ready to pick up the first food order.

10. The food locker system of claim 9, wherein one or both of:
the adding of the first food order to the preparation queue is responsive to the first check-in message; and
the instructing the first food locker to unlock a first food locker lock is responsive to the first check-in message.

11. (canceled)

12. The food locker system of claim 1, the operations further comprising:
receiving a second food order from a user computing device the second food order describing a second food item for pickup;
receiving, from the preparer user device, an indication that the second food order has been placed in a second food locker of the food locker bank;
determining that more than a threshold time period has passed since the second food order has been placed in the second food locker;
responsive to determining that more than the threshold time period has passed since the second food order has been placed in the second food locker, modifying the preparer user interface screen to indicate that a pick-up period of the second food order has expired; and
receiving, from the preparer computing device, an indication that the second food order has been cleared from the second food locker.

13. The food locker system of claim 1, the food locker bank comprising a first locker sub-bank at a first location and a second locker sub-bank at a second location, the first locker sub-bank comprising the first food locker, the operations further comprising:
determining that the first food order is for customer pick-up;
responsive to determining that the first food order is for customer pick-up, selecting the first food locker for the first food order;
determining that a second food order received from a second user computing device is for third-party pickup; and
responsive to determining that the second food order received from a second user computing device is for third-party pickup, selecting for the second food order a second locker of the second locker sub-bank.

14. (canceled)

15. A method of operating a food locker bank, comprising:
receiving a first food order from a user computing device the first food order describing a first food item for pickup;
adding the first food order to a preparation queue;
causing a preparer computing device to display a preparer user interface screen, the preparer user interface screen comprising a plurality of order elements including a first order element corresponding to the first food order;
receiving, from the preparer user device, an indication that the first food order has been placed in a first food locker of the food locker bank;
sending, to the user computing device, an indication that the first food order has been placed in the first food locker; and
instructing the first food locker to unlock a first food locker lock.

16. The method of claim 15, further comprising responsive to receiving the indication that the first food order has been placed in the first food locker, instructing the first food locker to illuminate a first food locker compartment of the first food locker.

17. The method of claim 15, further comprising:
receiving, from the preparer user device, an indication that the first food item order is ready; and
causing the preparer user computing device to modify the first order element to indicate the first food locker.

18. The method of claim 15, further comprising:
accessing first preparation condition data describing the first food order;
receiving a second food order from a second user computing device, the second food order being described by second preparation condition data; and
selecting the first food order for adding to the preparation queue using the first preparation condition data and the second preparation condition data.

19. (canceled)

20. The method of claim 15, further comprising:
accessing a first arrival time for the first food order;
receiving a second food order from a second user computing device, the second food order being described by a second arrival time, the second arrival time being before the first arrival time; and
selecting the first food order for adding to the preparation queue using the first arrival time and the second arrival time.

21.-22 (canceled)

23. The method of claim 15, further comprising receiving a first check-in message from the first user computing device, the first check-in message indicating that a user of the first user computing device is ready to pick up the first food order.

24. The method of claim 23, wherein one or both of:
the adding of the first food order to the preparation queue is responsive to the first check-in message; and
the instructing the first food locker to unlock a first food locker lock is responsive to the first check-in message.

25. (canceled)

26. The method of claim 15, further comprising:
receiving a second food order from a user computing device the second food order describing a second food item for pickup;
receiving, from the preparer user device, an indication that the second food order has been placed in a second food locker of the food locker bank;
determining that more than a threshold time period has passed since the second food order has been placed in the second food locker;
responsive to determining that more than the threshold time period has passed since the second food order has been placed in the second food locker, modifying the preparer user interface screen to indicate that a pick-up period of the second food order has expired; and
receiving, from the preparer computing device, an indication that the second food order has been cleared from the second food locker.

27.-28. (canceled)

29. A non-transitory machine-readable medium comprising instructions thereon that, when executed by at least one processor, causes the at least one processor to perform operations comprising:
receiving a first food order from a user computing device the first food order describing a first food item for pickup;
adding the first food order to a preparation queue;
causing a preparer computing device to display a preparer user interface screen, the preparer user interface screen comprising a plurality of order elements including a first order element corresponding to the first food order;
receiving, from the preparer user device, an indication that the first food order has been placed in a first food locker of a food locker bank;
sending, to the user computing device, an indication that the first food order has been placed in the first food locker; and
instructing the first food locker to unlock a first food locker lock.

30.-42. (canceled)
